(19) United States
(12) Patent Application Publication
(10) Pub. No.: US 2005/0143868 A1
(43) Pub. Date: Jun. 30, 2005

(54) Broadband data services over vehicle power lines

(76) Inventor: Anthony Whelan, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/020,766

(22) Filed: Dec. 23, 2004

Related U.S. Application Data
(60) Provisional application No. 60/533,351, filed on Dec. 30, 2003.
(60) Provisional application No. 60/564,247, filed on Apr. 20, 2004.

(51) Int. Cl. G06F 19/00

(52) U.S. Cl. 701/1; 701/19

(57) ABSTRACT

A method of providing broadband data services over power lines for moving vehicles is provided herein. Using broadband over power line (BPL) networking, a data signal is connected to a vehicle that is connected to a transport power line. The signal is communicated from the transport power line to the vehicle. The signal is then demodulated for use aboard the vehicle. The data signal connection allows for access to wide area networks such as the Internet. Access points can wirelessly broadcast wide area network signals from stationary locations to define meshed wireless networks in metropolitan areas.

### REFERENCE TO RELATED APPLICATIONS

This application claims the priority benefit under 35 U.S.C. §119(e) of U.S. provisional Application No. 60/533,351, filed on Dec. 30, 2003 and U.S. provisional Application No. 60/564,247 filed Apr. 20, 2004. The text of those applications is incorporated by reference in their entireties.

### BACKGROUND OF THE INVENTION

1. Field of the Invention

The present invention relates to the field of powerline networking.

2. Description of the Related Art

Network access is quickly becoming ubiquitous in industrialized countries. The Internet, an example of a wide area network, has enabled convenient worldwide communication. Broadband Internet access has significant penetration into both business and residential markets. Cable and DSL Internet allows users cheap, reliable, and fast Internet service. However, in smaller rural areas such services are generally not available because the physical data lines are not run to less populated areas.

In major cities, the Internet can be accessed from cell phones using general packet radio service (GPRS), and from personal digital assistants (PDA) and laptops using connection cards that access cellular-based networks. However, even in major metropolitan areas, the connection on commuter vehicles is less than stellar. Currently, a commuter can use a cell phone to make a data call to connect a laptop to the Internet or to connect using GPRS to a stripped-down version of the Internet viewable on the cell phone. However, these connections are very slow. Other options at similarly low speeds include using GPRS on a PDA and using cellular modems. A recently developed high speed option is satellite Internet. While download speeds are significantly faster than either GPRS or other cell services, reliability while the vehicle is in bad weather and/or in motion and upload speeds are problems associated with satellite Internet. Additionally, high saturation in satellite installations leads to high latency time in data delivery. A system of reliably delivering broadband Internet to electrically connected moving vehicles is desirable for the above reasons.

### SUMMARY OF THE INVENTION

In one aspect of the invention, a method of providing data services to a vehicle connected to a power line is provided. The method comprises connecting the power line to a broadband over power line data signal, communicating the data signal from the power line to the vehicle; and distributing the data signal to a set of passengers on the vehicle.

In another aspect of the invention, a system for delivering data to an electrically connected vehicle is provided. The system comprises a data server to provide a data signal, at least one medium voltage power line (MVPL) to provide a transportation medium for the data signal, a MVPL RF signal injector to connect the data signal to the MVPL, a MVPL RF signal extractor to demodulate the signal from the MVPL, a vehicle connected to the MVPL, and a network on the vehicle to deliver the data signal.

In another aspect of the invention, a vehicle with data access is provided. The vehicle comprises at least one passenger carriage, a network of low voltage power wires on the carriage that carry a data signal, and a plurality of electrical outlets connected to the low voltage power wires where data is made available to a plurality of users via the outlets on the vehicle.

In another aspect of the invention, a method of delivering wide area network based content to a moving vehicle is provided. The method comprises connecting to a broadband over power line (BPL) network that is in communication with the wide area network. A set of content from the wide area network is streamed to the vehicle and the content is displayed on the moving vehicle.

A system for delivering broadband access to a wide area network. The system includes a source for a data signal from the wide area network and a medium voltage power line. An RF signal injector communicates the data signal from the source to the medium voltage power line. A vehicle is connected to and powered by the medium voltage power line. A plurality of access points are connected to the power line and configured to distribute the data signal to a plurality of devices.

### BRIEF DESCRIPTION OF THE DRAWINGS

These and other aspects of the invention will be readily appreciated from the detailed description below and the appended drawings, which are meant to illustrate and not to limit the invention, and in which:

FIG. 1 is a schematic diagram of a preferred embodiment of the invention;

FIG. 2 illustrates a vehicle connected to a data signal offering wireless and powerline data access, in accordance with an embodiment of the invention; and

FIG. 3 illustrates a meshed network from a broadband-over-power-line (BPL) signal, in accordance with another embodiment of the invention.

### DETAILED DESCRIPTION OF THE PREFERRED EMBODIMENT

In a preferred embodiment, moving vehicles are connected to a network via broadband over power lines (BPL). In a preferred embodiment, the moving vehicles are electrically-connected vehicles, such as trains, monorails, electrically-powered buses and other vehicles that are connected to a power line. BPL systems couple RF energy onto power lines in order to deliver a data signal. Many industrialized countries use electrically connected trains for long-haul locomotive service. Examples of electrically connected long-haul trains include the French TGV and the multi-national Eurostar. Many local busses and “light rail” trains, such as San Francisco, Calif.'s MUNI and BART systems, also use electrically connected vehicles. The ability to have a fast and reliable wide area network connection while on these services would greatly benefit these passengers. The use of the Internet, an example of a wide area network, would allow passengers to send email, do research, and entertain themselves all while on a moving vehicle.

In one embodiment, a data signal is extracted from the power lines and supplied to the moving vehicle through wireless networking technologies to users. In this method, the signal can be used to provide network access to moving vehicles within the range of the wireless access points.

Broadband Over Power Lines

There are three major categories of powerline communications (PLC), two of which are capable of broadband data transfer. These three categories are control PLC, Access BPL, and in-house powerline networking. First, control PLC operates below 500 kHz, and is used by electric-utility companies to control their equipment using the power-lines as transmission lines. Examples include comparatively old diagnostic systems and newer systems capable of transmitting data to and from the power substation to control devices in a residence, to provide meter reading services, and to allow remote electrical disconnection.

In-house powerline networking is used within residences and business for home networking using the power lines in the building. The power outlets are used as networking ports, using transmission standards developed by the HomePlug™ Powerline Alliance, Inc. (San Ramon, Calif.). The HomePlug™ Alliance standard uses Intellon Corporation's (Ocala, Fla.) PowerPacket technology as its base. PowerPacket uses an enhanced form of orthogonal frequency-division multiplexing (OFDM) with forward error-correction, similar to the technology found in DSL modems. In-house BPL products are currently readily available on the retail market from companies such as NETGEAR® (Santa Clara, Calif.) and Siemens Subscriber Networks, Inc. (Dallas, Tex.).

Access BPL carries broadband Internet traffic over medium voltage power lines (MVPL). Medium voltage power lines (600-40,000 volts, often 750 volts to 1000 volts) are the electric lines that are generally at the top of electric utility poles beside roads in areas that do not have underground electric service. Typically there are three electric lines (called phases A, B and C), each carrying between 600 volts and 40,000 volts. One line is usually enough to power the houses on a residential street; two or even three phases can be joined together to power industrial or commercial areas. Companies such as Amperion, Inc., (Andover, Mass.) currently offer BPL systems for medium voltage lines.

Access BPL carries the data signal on medium voltage power lines from a point where there is a connection to a telecommunications network, such as a power substation or at an intermediate point between substations, depending on the network topology. The RF data signal is typically inductively coupled to the medium voltage power lines. The RF signal is typically transmitted as a spread spectrum, which allows the signal to travel over electrical lines which are also carrying thousands of volts at significantly lower frequencies. The data RF signal spectrum is usually within a range of 1-80 MHz. An inductive coupler transfers the communications signal onto the power line by wrapping around the line, without directly connecting to the line. Devices that couple the data signal onto the power line are known as injectors.

Delivering BPL to an Electrically-Connected Vehicle

Connecting the data signal to a train would preferably follow a procedure that begins with the injection of the RF signal onto a transport power line, a medium voltage power line (MVPL) that is connected to a moving vehicle. The signal is preferably injected at the train station or another upstream point. For example, the RF data signal could be injected at the power station in a process similar to the methods typically used for Access BPL systems. One method of injecting a signal onto a power line is described in U.S. Pat. No. 5,929,750, granted to Brown, which is incorporated by reference herein. Other methods of transmitting a signal over a power line could also be used in this system. Access BPL standards would be effective for transmitting data over the MVPLs.

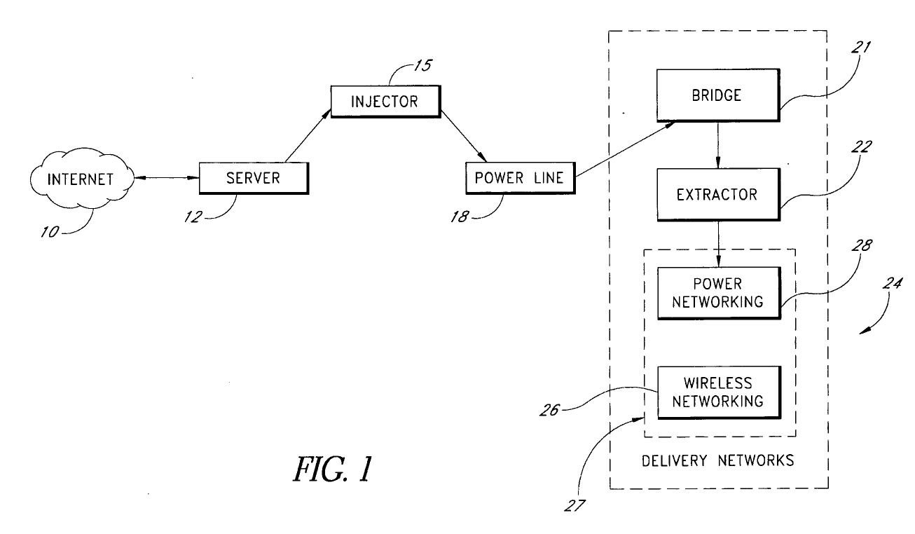

FIG. 1 is a diagram of a preferred embodiment. A server 12, which is connected to a wide area network such as the Internet 10, provides a data signal to a BPL injector 15. The BPL injector 15 modulates the signal onto a transport power line 18, preferably using inductive coupling methods. The signal travels on the transport power line 18 until it reaches an electrically connected vehicle 24 and its associated data extractor 22. The signal is bridged 21 over a transformer (not shown) and passed to the extractor 22. The extractor 22 demodulates the signal and passes it to a delivery network 27 on the vehicle 24. In this preferred embodiment, the data is offered through powerline networking 28 and/or wireless networking 26. In this embodiment, the bridge 21, extractor 22, and delivery networks 27, are all shown aboard the vehicle 24. However, various components may be positioned on the external power lines or elsewhere along the vehicle's route.

Electrically connected vehicles are typically connected in two fundamental connection types. The first is a lower rail, such as a third rail or a monorail. Typically, a third rail will carry approximately 750 volts to the train. A transformer is required to step the voltage down between the MVPL and the third rail. However, transformers usually operate at 60 Hz and can cause interference in the data signal. Several methods are now available that successfully avoid this problem. One such solution is the CT Bridge™ from Current Technologies, LLC (Germantown, Md.). This bridge acts as a gateway between the low voltage and medium voltage distribution systems.

Another method of avoiding interference by transformers is to simply demodulate the signal and run it around any transformer, either on the train or on a power line. Preferably, this is done by passing the signal over a signal cable, such as an Ethernet cable. The signal can then be reinjected onto other power lines, or it can be used to serve other networking access methods.

The other main type of electrical connection is an overhead connection. Many vehicles are connected through overhead wires by a device known as a pantograph on the roof of the vehicle. Typically, overhead wires carry approximately 25,000 volts, an amount very close to an average MVPL. However, a transformer will probably still be used to connect a standard MVPL to an overhead wire. Therefore, a bridge or similar device is used to connect the MVPL to the overhead wire.

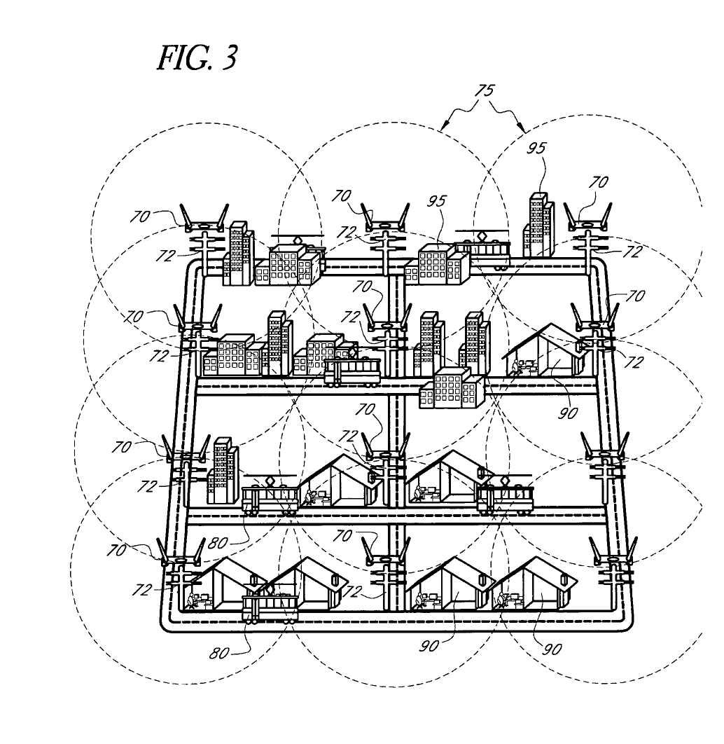

Another preferred embodiment includes extracting the signal from the overhead line or third rail and using wireless networking to bypass any vehicle machinery. Wireless access points on the transport power lines are preferably attached to the data signal extractors. The data signal is then accessed throughout the metropolitan area of the BPL network. Reference is made to FIG. 3 and corresponding description below.

Several wireless standards exist and are easily installed from retail packages or other systems. The two main wireless standards currently in use are the IEEE 802.11b standard and the 802.11g standard. While the 802.11g standard is faster, 802.11b is inexpensive and widely accepted in the industry. However, 802.11g allows for backwards compatibility with the older 802.11b standard. Additionally, another standard, 802.11n, is scheduled for ratification in 2005. A reliable line of sight transmittance circumference around each transmitter is about 200 meters. In the context of a metropolitan area network (MAN), if 802.11 wireless access points are placed within approximately 180 meters of each other, a meshed network is formed that would allow continuous access within the meshed region. Users within this meshed region, whether within a vehicle or not, would be able to receive the data signal. An example of such a meshed region can be seen in FIG. 3. The wireless access points 70 are connected to the power lines 72. These create wireless “bubbles” 75 which allow users within the vehicles 80, houses 90, and office buildings 95 to access the data signal, together overlapping to define a meshed wireless network. Thus, wide area wireless access to the wide area network (Internet) is facilitated by taking advantage of available power lines employed for powering public transportation in metropolitan areas.

Using this meshed network, the user would be changing access points very often when riding on a moving vehicle. Even non-electric vehicles can take advantage of such wireless systems, provided the proper receiving equipment is installed. A conventional automobile 12 volt power source is sufficient to power such devices. In order to ensure reliable connection, services such as a Radius server will be utilized. Programs like Cisco Systems' (San Jose, Calif.) TACACS+ software system allow for rapid authorization. TACACS+ can also be used to restrict a user to a specific zone or region.

A common problem with BPL is that the signal will fade out over longer distances. This will be particularly true in the case of long-distance trains because they are often long distances away from major cities. In order to combat this problem, repeaters, devices which decode the signal, remove noise, and re-inject the signal onto the line, can be used to maintain the signal. Repeaters are typically spaced along the line to facilitate the strength of the data signal being sent along the line. It is common for repeaters to be spaced about 2,000 feet apart from each other. When using MVPLs which connect moving electrically connected vehicles, the noise can be substantially greater than a typical power line. For this reason, additional repeaters are preferably used on the line that delivers power to the vehicle in order to preserve the signal strength. Preferably, the repeaters are spaced less than 2,000 feet apart, more preferably less than 1,500 feet apart, and most preferably less than 1,000 feet apart.

In the case of either an overhead wire or a third rail, the possibility of a heightened level of noise could complicate the implementation of BPL for electrically connected vehicles. However, when using standard networking protocols, such as transmission control protocol (TCP), internet protocol (IP), File Transfer Protocol (FTP), and Simple Mail Transfer Protocol (SMTP), error-correcting features of the protocols will correct for many of these interference problems. TCP is preferred over protocols such as the user datagram protocol (UDP) because TCP has better correction features. Features of TCP include a three-way acknowledge and packet checksum procedure and a time-out mechanism for lost packets. With TCP, if the data is not correct, a checksum or other error will be detected. The data packet will then be resent. Even many such failures would not cause significant bandwidth loss.

However, some of the failures can also be designed around. In a preferred embodiment, additional low frequency filters are used to eliminate low frequency noise throughout the line. Additional modifications to the injection of the signal onto the line could also be made. For example, in typical Access BPL, a broad spectrum from approximately 1 MHz to 80 MHz is used. The range of this spread spectrum could be modified to reduce interference suffered by the signal on the third rail or overhead wire. Additionally, advanced spread spectrum techniques can be used to reduce intereference with external devices. Techniques such as code division multiple access (CDMA) will prevent interference with traditional radio frequencies.

Delivering BPL to the Passengers

The signal is preferably then extracted from the power line in order to serve the passengers. A method of receiving the data signals and a receiving device is also described in the Brown '750 patent referenced above. The demodulation of the data signal would be in accordance with Access BPL standards and any Federal Communications Commission (FCC) regulations stipulated under Volume 15 of the Code of Federal Regulations, regulating the transmission of RF signals.

Once the train or other electrically-connected vehicle is connected to the network, Internet access is delivered in one of several ways. One of these ways is using the power outlets of the electrically-connected vehicle. Using HomePlug™ standard equipment, the data signal is injected onto the power wires of the electrically connected vehicle. In the preferred embodiment of a train, the network can either be local to each car, or the cars can be connected by the power wires that run between the cars. HomePlug™ adaptors can be connected to the power wires in the train and configured to provide what appears to be a standard Ethernet port for train passengers. Power outlet adaptors are readily available on the market and provide an Ethernet port that is connected to the HomePlug™ network.

Another preferred method of delivering the Internet access is using a wireless network. Preferably, wireless access points are positioned so that a wireless user at any point in the electrically connected vehicle would be able to use the Internet access; more preferably, a user would be able to use the maximum bandwidth capability of their wireless equipment.

Devices to be connected to the network can include computers, such as laptop computers, and personal digital assistants (PDA), such as Palm OS® or Pocket PC devices. Other devices can be connected to the network, but they are preferably compatible with either standard wireless protocols or Ethernet cable connections.

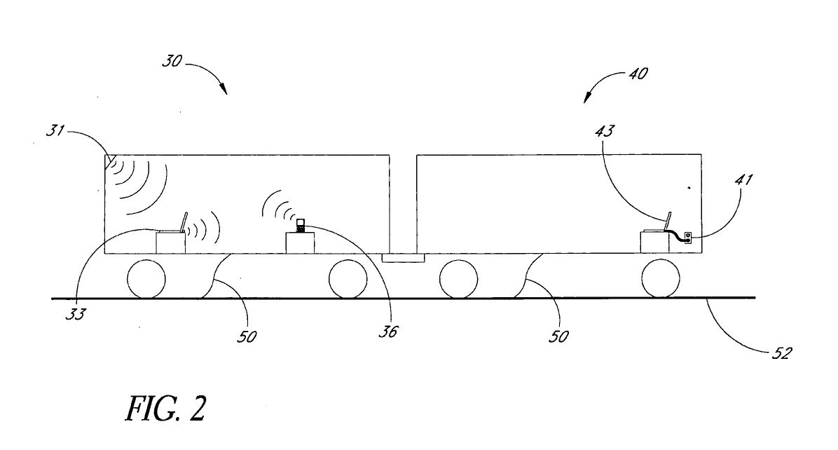

In FIG. 2, a vehicle is shown connected to a third rail 52. Data is delivered to the vehicle through a connection 50 to the third rail. A carriage 30 is shown with devices using wireless networking access delivered to the train over the third rail 52. A wireless access point 31 provides data access to a laptop 33 and a PDA 36. In a second carriage 40, a laptop 43 is shown connected to an electrical outlet 41 which provides data access using HomePlug™ powerline networking. It will be understood that one could have wireless access or hardwired outlet access or both in any given carriage.

In another preferred embodiment, the vehicle will be equipped with built-in connected terminals, such as in-seat computer systems. In a preferred embodiment, the moving vehicle carries a media content delivery system. Such a system would comprise a data receiver, such as a computer, and a data output device, such as an audiovisual monitor. Examples of audiovisual monitors include cathode ray tube (CRT) screens, liquid crystal display (LCD) screens, or a television. Data would be constantly streamed to the data receiver, allowing for constant refresh of the data being displayed. Additionally, the media content delivery system preferably includes a speaker system to play received audio signals. This would allow for entertainment and advertising to be delivered to all riders of the vehicle. In one embodiment, the LCD screen could be a scrolling text ticker that allows only one-way communication.

In a preferred embodiment, every seat will have access to a computer screen that will allow every customer access to information on the train or other moving vehicle. The in-seat computers will be directly connected through powerline networking or could be connected through a wireless connection. In another preferred embodiment, the moving vehicle could have a specific area wherein a user could access the networking capabilities of the broadband over powerline. In this preferred embodiment, a train could have a specific car which carried the computers for Internet access provided by BPL. Preferably, when the in-vehicle computers are not in use, they are used for advertising to be shown to the riders of the moving vehicle.

Whether the computer screen is located in a specific carriage or at individual seats, the real-time data connection will allow users to determine at which stop they should get off for particular destinations. Users would also be able to book entertainment tickets, schedule taxi or shuttle pickup, check-in for airline and connecting trains and other interactive services. The media content delivery system could also deliver multimedia entertainment. For example, in some transportation vehicles, taped entertainment is provided to the passengers. Using the broadband data signal, live programming could be streamed to the passengers.

Other Network Applications

An additional benefit of BPL is that the connection is symmetrical. That is, the upload and download speeds are approximately equal. Symmetrical data signals usually have upload speeds that are within 15% of the download speed (i.e., upload speed is between 85% and 115% of the download speed). This allows for large amounts of data to be sent from the vehicle, enabling bandwidth-heavy applications. Many applications can use the high quality network access that is provided by the BPL connection. Because of the consistent upload and download speed and quality, security cameras and other security devices that require a lot of bandwidth can be placed throughout the electrically connected vehicles. In a preferred embodiment, the camera sends a video feed or a sequence of still photographs to a vehicle security command or other monitoring facility. The recordings can be viewed later or can be constantly monitored. In another preferred embodiment, a security panic button will be placed in every seat. When the panic button is activated, the camera begins recording a feed and preferably produces an audible warning tone.

Another application of the network access is the ability to locate the position of specific passengers. This will allow parents to locate their children, and hosts to anticipate their guests' arrival. Preferably, the BPL hardware used serve the network access will be able to determine where the train is located along the power line. In a preferred embodiment, when a user gives permission to allow such locating, location data will be sent to another user on the Internet. Permission could be given globally, or only to specific users. Exemplary methods of communication to the tracking user include an automated telephone message, text messages to cell phones, email, Internet instant messaging, and a web-based notification system.

The network can also be used on the train for voice over Internet protocol (VoIP). Because VoIP uses the Internet, rather than the standard telecom network, the cost is very reasonable. However, VoIP can be used for telephone conversations that connect to standard telecom systems. Other Internet applications, such as e-mail, and webcam use could also be available on the electrically connected vehicles.

### EXAMPLE

As an example, French TGV™ trains use 25 kV/50 Hz single phase overhead power and convert the power to 1500V/50 Hz by using a massive 8-ton transformer. The signal, which is injected at upstream point, such as the train station, is transmitted along the overhead MVPLs. Repeaters are preferably spread liberally over this line in order to ensure the quality of the data signal over the line. A bridge or other method could be used to get around the transformer and other train machinery, which could be a major source of noise and interference for the data signal. In a preferred embodiment, the signal is extracted before the transformer and skips the 1500V/50 Hz lines and is only re-injected onto 110/220 V power lines. This saves one step of injection and extraction, which preserves the data quality and keeps costs down.

After the data has been extracted, it can then be used to serve a data transmission signal to passengers, preferably using power outlets and/or wireless access points along the carriages.

Connections for External Users

The Internet connection can also be configured to provide Internet access to stations and areas that are near the transport power lines. For example, train stations can use the lines that are running through them, such as the third rail and overhead lines. The signal can be connected to a wireless adaptor or router or any other networking service. This Internet connection can then be used by users waiting for trains or by station operators, vendors, or other retail operators. This is especially useful for stations in remote locations where broadband wide area network access would not ordinarily be available. Reference is again made to FIG. 3 and corresponding text above; note that the transmission to such remote locales can be useful even through hardwired connections, rather than wireless connections.

It will be appreciated by those skilled in the art that various omissions, additions and modifications may be made to the methods and structures described above without departing from the scope of the invention. All such modifications and changes are intended to fall within the scope of the invention, as defined by the appended claims.

1. A method of providing data services to a vehicle connected to a power line comprising
connecting the power line to a broadband over power line data signal;
communicating the data signal from the power line to the vehicle; and
distributing the data signal to a set of passengers on the vehicle.

2. The method of claim 1, wherein connecting the power line to the data signal comprises injecting the data signal onto a third rail.

3. The method of claim 1, wherein connecting the power line to the data signal comprises injecting the data signal onto an overhead wire.

4. The method of claim 1, further comprising repeating the data signal on the power line.

5. The method of claim 4, wherein repeating the data signal on the power line comprises
extracting the data signal from the power line; and
reinjecting the data signal onto the power line.

6. The method of claim 1, wherein connecting the power line to the signal comprises connecting the power line to a RF data signal.

7. The method of claim 6, wherein connecting the power line to the RF data signal comprises connecting the power line to a spread spectrum signal.

8. The method of claim 1, wherein connecting the power line to the data signal comprises connecting the power line to a symmetrical data signal.

9. The method of claim 1, wherein distributing the data signal comprises using wireless networking.

10. The method of claim 1, wherein distributing the data signal comprises providing a plurality of connected terminals built into the vehicle.

11. The method of claim 10, wherein providing the connected terminals comprises providing a plurality of media content systems comprising a data receiver and an output device.

12. The method of claim 1, further comprising providing a plurality of security cameras connected to the data signal.

13. The method of claim 1, further comprising providing the data signal to users outside of the vehicle using wireless networking.

14. A system for delivering data to an electrically connected vehicle comprising
a data server to provide a data signal;
at least one medium voltage power line (MVPL) to provide a transportation medium for the data signal;
a MVPL RF signal injector to connect the data signal to the MVPL;
a MVPL RF signal extractor to demodulate the signal from the MVPL;
a vehicle connected to the MVPL extractor; and
a network on the vehicle to deliver the data signal.

15. The system of claim 14, wherein the network comprises a wireless network.

16. The system of claim 14, wherein the network comprises a HomePlug™ powerline network.

17. The system of claim 14, wherein the MVPL comprises a third rail.

18. The system of claim 14, wherein the MVPL comprises overhead wires.

19. A vehicle with data access comprising
at least one passenger carriage;
a network of low voltage power wires on the carriage that carry a data signal within the carriage; and
a plurality of electrical outlets connected to the low voltage power wires where data is made available to a plurality of users via the outlets on the vehicle.

20. The vehicle of claim 19, further comprising a transport power line that provides the data signal to the passenger carriage.

21. The vehicle of claim 19, wherein the transport power line comprises a medium voltage power line.

22. A method of delivering wide area network based content to a moving vehicle comprising
connecting to a broadband over power line (BPL) network that is in communication with the wide area network;
streaming a set of content from the wide area network; and
displaying the content on the moving vehicle.

23. The method of claim 22, wherein displaying the content on the moving vehicle comprises displaying the content on an audiovisual monitor on the moving vehicle.

24. The method of claim 22, wherein streaming comprises wirelessly communicating the data from spaced injection points along the power line to the moving vehicle.

25. The method of claims 22, wherein streaming comprises connecting the power line physically to the vehicle.

26. A system for delivering broadband access to a wide area network, the method comprising:
a source for a data signal from the wide area network;
a medium voltage power line;
an RF signal injector communicating the data signal from the source to the medium voltage power line;
a vehicle connected to and powered by the medium voltage power line; and
a plurality of access points connected to the power line and configured to distribute the data signal to a plurality of devices.

27. The system of claim 26, wherein the plurality of access points are distributed in the vehicle.

28. The system of claim 27, wherein the plurality of access points comprise electrical outlets on the vehicle.

29. The system of claim 26, wherein plurality of access points comprise stationary wireless transmitters along the power line.

30. The system of claim 29, wherein each of the plurality of access points is positioned within about 180 meters of another of the plurality of access points.

31. The system of claim 29, wherein the plurality of access points have overlapping transmittance ranges to define a meshed region of access to the data signal.
